(19) United States
(12) Patent Application Publication
(10) Pub. No.: US 2014/0266546 A1
(43) Pub. Date: Sep. 18, 2014

(54) High Density Packaging for Efficient Power Processing with a Magnetic Part

(71) Applicant: Hengchun Mao, Allen, TX (US)

(72) Inventor: Hengchun Mao, Allen, TX (US)

(21) Appl. No.: 14/187,249

(22) Filed: Feb. 22, 2014

Related U.S. Application Data
(60) Provisional application No. 61/852,365, filed on Mar. 15, 2013.

(51) Int. Cl. H01F 27/28; H01F 41/04

(52) U.S. Cl. CPC H01F 27/2804; H01F 41/041; H01F 2027/2819
USPC 336/200; 29/606

(57) ABSTRACT

A package comprises a substrate with a plurality of metal tracks, a via hole formed in the substrate, wherein the sidewall of the via hole is partially plated and the via hole is filled with a magnetic material, and a first winding magnetically coupled to the via hole.

### CROSS REFERENCE TO RELATED APPLICATIONS

This application is related to, and claims priority to U.S. Provisional Application No. 61/852,365, titled, “High Density Power Packaging for High Efficiency Power Processing” filed on Mar. 15, 2013, which is herein incorporated by reference.

### TECHNICAL FIELD

The present invention relates to packaging technologies, and, in particular embodiments, to high density packaging technologies for high frequency and high efficiency power processing devices and systems.

### BACKGROUND

Power processing devices include power amplifiers and power converters. A power amplifier amplifies its input power to output a higher amount of power in a similar characteristic to the input power's. A power converter converts an input power to an output with a different form from the input's. Power processing devices are widely used in electronic devices, equipment, and systems.

A power processing device usually has one or more magnetic parts. The magnetic part usually takes significant portion of the size, volume and weight of the power processing device, and consumes a big portion of energy processed by the electronic device. As customers demand smaller size and higher efficiency from the electronic devices, especially in mobile devices, the current packaging technique cannot meet the expectation. Novel packaging technique is needed to address the customer needs.

### SUMMARY OF THE INVENTION

These and other problems are generally solved or circumvented, and technical advantages are generally achieved, by preferred embodiments of the present invention which provides an improved resonant power conversion.

In accordance with an embodiment, a package comprises a substrate with a plurality of metal tracks, a via hole formed in the substrate, wherein the sidewall of the via hole is partially plated and the via hole is filled with a magnetic material, and a first winding magnetically coupled to the via hole.

In accordance with another embodiment, a system comprises a substrate comprising a printed circuit board, a first winding comprising a metal track on the substrate, a magnetic material deposited to the first winding and forming a magnetic core, and a connection pad to electrically couple a circuit in the substrate to outside.

In accordance with yet another embodiment, a method comprises providing a substrate with a first set of metal tracks, depositing a magnetic material to the first set of metal tracks to make a magnetic core, and connecting the first set of metal tracks vertically by vias or metal posts to a second set of metal tracks to form a winding.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a schematic diagram of a power amplifier;

FIG. 2 illustrates a schematic diagram of a dcdc power converter;

FIG. 3 illustrates a schematic diagram of a two-phase dcdc power converter;

FIG. 4 illustrates a schematic diagram of an isolated power converter;

FIG. 5(a) illustrates a schematic diagram of a wireless power transfer system;

FIG. 5(b) illustrates a magnetic structure of a wireless power transfer system;

FIG. 6(a) illustrates a power processing system in accordance with various embodiments of the present disclosure;

FIG. 6(b) illustrates a magnetic core of a power processing system in accordance with various embodiments of the present disclosure

FIG. 7 illustrates a power processing system with two magnetic components coupled together in accordance with various embodiments of the present disclosure;

FIG. 8 illustrates a power processing system with partially plated vias in accordance with various embodiments of the present disclosure;

FIG. 9 illustrates a cross section drawing of a magnetic part with partially plated vias without core material in accordance with various embodiments of the present disclosure;

FIG. 10 illustrates a cross section drawing of a magnetic component with partially plated vias with core material in accordance with various embodiments of the present disclosure;

FIG. 11 illustrates a magnetic component with multiple windings in accordance with various embodiments of the present disclosure;

FIG. 12 illustrates another magnetic component with multiple windings in accordance with various embodiments of the present disclosure;

FIG. 13 illustrates a structure with multiple magnetic components with multiple windings in accordance with various embodiments of the present disclosure;

FIG. 14 illustrates a magnetic component with windings on multiple layers of a substrate in accordance with various embodiments of the present disclosure;

FIG. 15 illustrates a magnetic component on a substrate in accordance with various embodiments of the present disclosure;

FIG. 16 illustrates a package with a magnetic component on a substrate in accordance with various embodiments of the present disclosure; and

FIG. 17 illustrates magnetic structures with cutouts in accordance with various embodiments of the present disclosure;

Corresponding numerals and symbols in the different figures generally refer to corresponding parts unless otherwise indicated. The figures are drawn to clearly illustrate the relevant aspects of the various embodiments and are not necessarily drawn to scale.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely in electronic packaging for power conversion devices and systems. The invention may also be applied, however, to a variety of other electronic devices and systems. Hereinafter, various embodiments will be explained in detail with reference to the accompanying drawings.

High density packaging is required for many electronic devices and systems, especially in mobile devices such as smart phones. Power related functions, such as power amplifiers and power converters, usually take a significant portion of a device or a system's volume and area. It is important to increase the packaging density of power processing devices and systems.

There are different power processing technologies. FIG. 1 shows the block diagram of a radio-frequency (RF) power amplifier. L1 is the RF choke, C1 is the bypass capacitor, and C2 is the dc block capacitor. S1 is the main RF power switch, which is shown as a MOSFET but can be a bipolar transistor and other appropriate devices too. There are other circuits such as bias circuit, signal conditioning circuit, and impedance match circuit in a power amplifier too. Usually, the RF choke L1 and other magnetic components physically take a significant portion of the amplifier's size and volume. Power converters are also important parts of an electronic system. FIG. 2 shows the topology of a buck converter. S1 is the control switch, and Sd is the synchronous rectifier. L1 is the power inductor. Co is the output filter. In most systems, the inductor L1 takes a significant portion of the volume of the power converter. To reduce the size of the inductor, often multiple interleaved phases are used, and the inductors in all the phases can be coupled. FIG. 3 shows the topology of a two-phase configuration, in which L1 and L2 are magnetically coupled. Depending on the system requirements, the inductors can be positively coupled (the flux in an inductor is increased by the coupling), or inversely coupled (the flux in an inductor is reduced by the coupling). However, usually the inductors are still the biggest part of the converter. FIG. 4 shows a block diagram of a multi-output isolated power converter (two outputs are shown) based on class E topology. Sp1 is the main switch, L1 is the input inductor. Cp1 is a parallel capacitor across Sp1 and includes the effect of Sp's output capacitance. Crp, and Cr1 through Cr4 are resonant capacitors, which resonant with the leakage inductance of power transformer T1. Additional discrete inductors can be added if the transformer's leakage inductance is not enough. L1 and Cp1 will join the resonance when Sp1 is turned off. Sp1 can be turned on with zero voltage, and turned off with a slow voltage rise, and thus its switching loss is minimized. Synchronous rectifiers S1 through S4 rectify the ac currents in the transformer's secondary windings n2 and n3, and can be replaced by diodes when needed. The output capacitors C1 and C4 smooth the output voltages V1 and V2. The series resonant tanks created by Cr1 through Cr4 in the secondary side of the transformer with the transformer's leakage inductance should have the same equivalent parameters as the primary resonant tank's created by Crp in the primary side when all elements are transferred to the primary side. In this way, the double-side resonance in the transformer's primary and secondary circuits can improve the regulation of the output voltages. In this topology, magnetic parts L1 and T1 are usually the biggest parts in the whole converter. FIG. 5(a) shows a wireless power transfer (WPT) system block diagram, in which the power transmitter 510 and the power receiver 520 may be physically separated. The coil L1 in the transmitter 510 and the coil L2 in the receiver 520 are magnetically coupled, and can be considered to form a transformer, with L1 as the primary winding and L2 as the secondary winding of the transformer. To improve the system efficiency and shield the noise from the WPT system, it is desirable to have a magnetic core coupled to one side of the receiver winding, and another magnetic core coupled to one side of the transmitter coil, as is showing in FIG. 5(b). Therefore the magnetic cores are important in a WPT system too.

The size of a magnetic part can be reduced by applying high density packaging techniques. This disclosure discusses several novel magnetic packaging techniques to reduce the height and volume of magnetic cores.

Currently, most magnetic designs use discrete cores in various shapes. FIG. 6 shows an example. A substrate, such as a printed circuit board (PCB) consisting of FR4 material or BT material or a lead frame, is used to hold various components, such as active components, passive components, and connectors. Connectors, such as 110 in the drawing, may be just plated pads on the substrate, and some connector pads may have edge plating, as 120 is shown in the drawing. The substrate can be a flexible PCB, or a rigid PCB. The active components (integrated circuits and discrete semiconductor devices such as MOSFETs, BJT, and diodes) can be packaged devices or bare dies. A magnetic part (a RF choke, an inductor or a transformer) consists of one or more conductive windings magnetically coupled to one or more magnetic cores. The magnetic part can be a discrete part, but increasingly the winding (or windings) is integrated with the substrate in a high-density system. The core is usually a discrete part, as shown in FIG. 6(b). Due to the mechanical property of available core materials, the core is usually quite thick, having a thickness more than usually 0.5 mm. A core can be magnetically coupled to multiple windings, which may be from one magnetic part, or multiple magnetic parts, as is shown in FIG. 7, in which wingding 130 and winding 140 are coupled to a single magnetic core.

To reduce the size of a magnetic part, sometimes the core material is plated or otherwise bounded to a semiconductor die. Such an approach has significant power and efficiency limitation, because a process compatible with semiconductor technologies cannot produce big or thick features for the core and the winding.

Therefore, it is more advantageous to integrate the core with a substrate for a power processing device or system such as a power amplifier, or a power converter. FIG. 8 shows an exemplary implementation. All or part of conductive windings is integrated onto a substrate as traces or tracks in the substrate. The exposed conductive tracks in the magnetic part may be used as part of the seed layer and may be modified to get better core shapes. For areas where the core material is desired to go inside the substrate to form a magnetic path vertical to the surface of the substrate, such as in the center of a spiral winding, big vias with partial plating can be drilled. As is well known in the industry, a via is a hole in a substrate, and its sidewall can be plated to conduct a current. The plating of a via (on the sidewall and on the pads associated with it) works as part of a seed layer to attract the core material in later processing, but the plating on the sidewall cannot form a full circle, as a full circle will be a short circuit which nullifies the effect of the magnetic material inside the via. Therefore, the sidewall of a via intended for use as part of a magnetic core should be just partially plated and the metal on the sidewall should not form a closed circle. Please also note that such a partially plated via used for magnetic material filling can also be part of a winding, or be connected to a winding, as it can still conduct an electrical current. A via with complete plating in the core area should not be used for magnetic material filling, and can be filled with a non-magnetic material, or covered by a resistance material to prevent the core material from entering the hole. Moreover, multiple coils can be used in one or more layers of the substrate. Two coils are shown in FIG. 8(a), coupled to one core shown in FIG. 8(b). The two coils can be from one or two magnetic parts. If they belong to one part, the flux directions in the two center portion can be made opposite so the magnetic part is a bipolar structure. A bipolar structure is useful for high power applications in which more winding area is needed, and for WPT applications in which the bipolar structure forms a half closed magnetic path and can improve the magnetic coupling between transmitter and receiver. The core material is deposited onto the desired area by one of the following methods:
1. Plating or sputtering. The exposed metal tracks in the desired area are part of a seed layer for the magnetic core material. If needed, additional seed layers can be deposited onto the surface of the tracks and nearby substrate surface. The additional seed layers shall not be electrical conductive to avoid shorting the tracks if more than one tracks are exposed. More than one seed layers also allow the magnetic materials to form a relatively thick core with multiple thin layers of magnetic material, thus the eddy current loss in the core is low. However, if only one track is exposed in the area, any seed layer, conductive or non-conductive, can be used. Multiple turns or windings can still be formed in this single exposed track structure by putting them in other layers including inside layers. If needed, resistance material can be applied to areas where core material deposition is not needed. The core material, such as a NiFe, CoFe or CoFeCu alloy, can be deposited onto the area through a seed layer by plating, sputtering or other method. FIG. 9 shows the cross section of a magnetic component before magnetic material deposition. The substrate may be a double-layer or multi-layer PCB, but internal layers are not shown. The dielectric material inside the substrate is not magnetic, so can be used as air gaps if needed. FIG. 10 shows the cross section of the magnetic part after magnetic material plating. A thin layer of magnetic material, whose thickness may be several tens of micrometers to several hundreds of micrometers, is formed in the desired area. The core material may fully or partially fill the partially plated vias to form vertical magnetic paths 1010 to conduct flux vertically. A magnetic gap 1020 may be created in the magnetic part with dielectric material in the substrate. Also, the core material may fully or partially cover the conductive tracks and fill the clearance gaps between them. Although a full filling/covering (shown in FIG. 8(b) and FIG. 10) is usually more desired, but in some designs partial filling/covering may be desired to create additional air gaps.
2. Screen plating, ink printing, and dispensing. The desired area(s) can be deposited with a seed layer, or coated with a thin glue layer. Then a compound of soft ferrite powder (such as NiZn powder or MnZn powder) and polymer binder can be applied onto the desired area(s) through screen plating or similar methods. The printed substrate then is heated one or more times at appropriate temperatures to cure the material and form a strong bonding.

The core material plating or printing can be performed in array form, before, during, or after other components are placed and soldered.

The structure 1010 has vias filled with a magnetic material, and can form a vertical magnetic path with low magnetic reluctance. FIG. 10 also shows an exemplary implementation 1020 using the dielectric material inside the substrate as air gaps. The dielectric material may be as thin as 0.05 mm, or as thick as several mm, so there is a wide range to work with to select a right gap length. Conductive tracks can be placed on different layers, so multiple windings with enough electric isolation can easily be obtained if desired. This is especially useful for coupled inductors as is shown in FIG. 3, or for transformers. There are many different ways to arrange the windings. FIG. 11 shows that one winding can be split in different layers. Please note that vertical magnetic paths 1110, 1120, and 1130 are formed in this structure, and different magnetic coupling between windings can be obtained by having different magnetic reluctances in these vertical paths. FIG. 12 shows that one winding is only in one layer. In this way, a high voltage isolation can be easily obtained between windings. FIG. 13 shows that multiple magnetic parts can be vertically integrated in the same area. A PCB can be manufactured by laminating several subassemblies, with each subassembly having two or more layers. One part may be manufactured on a subassembly, and other part may be manufactured on another subassembly in the same area to reduce the foot print of magnetic components. As well known in the industry, such a laminated structure allows blind and embedded vias be manufactured relatively easily. Blind or embedded vias can be filled with a magnetic material so the length of an air gap in the vertical magnetic path can be controlled. If the distance between the magnetic parts is much longer than the air gap length in each magnetic part, the cross coupling between the parts may be negligible. Multiple windings can be used in each part, and windings in the parts can be electrically in series or in parallel. The possibility to have multiple windings in a part, and have multiple parts in an area provides flexibility in system design.

FIG. 14 shows a cross section of a part, in which multiple layers are used for the winding(s). For applications needing high electrical insulation such as in ac input circuit or high voltage circuit, the core material and/or windings can be contained in the internal layers of a PCB, so the dielectric material of the PCB can help meet insulation requirements.

Due to the flexibility of core shapes and winding shapes with the above techniques, the magnetic parts can have spiral, race-track, slug or other forms of windings. Core materials can be deposited around the windings to form high density magnetic structures. When needed partially plated vias can be used to form a vertical magnetic path filled with magnetic material. FIG. 15 shows a slug part with core material deposited around a winding. For structures with windings outside the core such as in a toroid shaped magnetic component, similar technology can be used. In one embodiment, the core can be deposited on an internal layer of a PCB, and conductive tracks are split into different layers and are connected vertically by electrical conducting vias to form a complete winding. Of course, other connecting means such as metal posts are also possible, and core material doesn't have to be deposited on an internally layer. In another embodiment, a plurality of metal tracks is provided on an out layer of the substrate, and the core is deposited onto the metal track. Metal posts connect the metal tracks vertically to another substrate or a lead frame where additional metal tracks are configured so a complete winding is formed. In this way, a metal post plays the same function as a via, but provides more flexibility. High density air core toroid inductors with flux contained inside a PCB can also be made this way with vias or metal posts as the key connecting means. Multiple windings can also be formed to create a complex circuit structure, such as multiple outputs, coupled inductors with positive or inverse coupling, and multiple-winding transformers.

For some applications such as WPT applications, the magnetic path is not closed in the transmitter or receiver, so the core material should be on one side of the substrate, with or without vertical path. It may be desirable to put other components on the side with cores, so the height of the whole assembly is minimized. FIG. 16 shows the cross section for such an arrangement. The non-component side has only conductive tracks on it, so has a relatively flat surface. Such surface can be thermally coupled to another structure to transfer heat out. For example, in a smart phone, it can be coupled to a cover for thermal conduction and/or mechanical support. Please note that the vertical structure 1620 with core material in it also helps to shield other components on the substrate from the noise generated by the current inside the magnetic part 1610.

In some applications it may be desired to use one side of the substrate as interconnection interface, for example in land grid array (LGA) packages. In such applications the magnetic and other parts can be put on the other side of the substrate, and when necessary core material can be deposited in internal layers of the substrate, similar to the concept shown in FIG. 16. Then some copper pads in the non-component side of the substrate can serve as the connectors to connect the circuit or components on the substrate to outside circuits.

A large core may have intentional cut outs, as is shown in FIG. 17. The cut outs may be created with resistance material during the deposition process. The cut outs can help maintain a high quality in the deposition process, and help the cooling of the magnetic part. The cut outs may be arranged in a direction approximately vertical to the winding current's direction, providing more resistance to eddy currents in the core while having no significant impact on the flux, and thus reducing power loss in the core.

In addition to power processing components, other system components can also be assembled on to the substrate. For example, the LED power supply substrate may also host LED chips, and the LED chips may be placed in a way to allow special packaging process dedicated to LED chips to be applied easily and with low cost. For example, the LED chips may be placed in one or multiple concentrated areas, or they can be placed in one side of the substrate while other components are placed on the other side of the substrate. The substrate such as a flexible PCB may be bent in a way to allow the light emitted from the LED chips to have better patterns and directions. Multiple power converters may be hosted by one substrate, and one substrate may just host part of a power converter or power processing circuit. In mobile devices, the power substrate may host one or more power converters together with other power processing circuits such as RF PAs. Other system functions, for example, system functions such as sensing circuits, communication circuits including RFID, NFC (near field communication) and Bluetooth ICs, power management, and signal processing circuit may be hosted on a power substrate to make a module with both power and system functions. A magnetic part may be shared by power and system functions. For example, a core may be coupled to a WPT transmitter or receiver coil and a NFC coil. A WPT transmitter or receiver coil may be used also for system functions such as NFC, RFID, or Bluetooth, or as an antenna for other RF systems. Also, the ICs of a power converter may be integrated with both power and system functions, especially communication functions as discussed above, in the same die or in a multi-module module. The parasitic inductance in the package level can be controlled so that it serves as a magnetic part. Such share of components between power processing and system functions in an IC or magnetic parts can significantly improve system density and other performances.

The whole or part of the assembly may be protected by plastic molding for environment protection and the molding may serve also cooling and EMI filtering purpose.

The substrate can be an electrical conductive metal wire or bar which serves as the winding of a magnetic part. With appropriate core material deposited on part or all of the wire or bar's surface areas, it becomes a discrete magnetic part.

Although embodiments of the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A package comprising:
a substrate with a plurality of metal tracks;
a via hole formed in the substrate, wherein the sidewall of the via hole is partially plated and the via hole is filled with a magnetic material; and
a first winding magnetically coupled to the via hole.

2. The package of claim 1, wherein the first winding comprises a plurality of metal tracks in the substrate.

3. The package of claim 2, wherein a magnetic material is deposited on to the first winding to form a magnetic core.

4. The package of claim 3, wherein the magnetic material is configured such that a gap exists in the magnetic core.

5. The package of claim 3, wherein the magnetic core has a cut out.

6. The package of claim 3, wherein a plurality layers of the magnetic material is deposited with a plurality of non-conductive seed layers in the magnetic core.

7. The package of claim 3, wherein a second winding comprising a plurality of metal tracks on the substrate is deposited with a magnetic material and magnetically coupled to the first winding.

8. The package of claim 6, wherein the first winding and the second winding form a bipolar structure.

9. The package of claim 3, wherein the substrate comprises a print circuit board.

10. The package of claim 9, where the magnetic material is filled into a blind via or an embedded via in the substrate.

11. The package of claim 9, wherein a magnetic gap is formed by the dielectric material of the substrate.

12. The package of claim 9, wherein the printed circuit board has more than one subassemblies, wherein a first magnetic part is in a first subassembly and a second magnetic part is in a second subassembly in the same area.

13. A system comprising:
a substrate comprising a printed circuit board;
a first winding comprising a metal track on the substrate;
a magnetic material deposited to the first winding and forming a magnetic core; and
a connection pad to electrically couple a circuit in the substrate to outside.

14. The system of claim 13, wherein the system further comprises an active part.

15. The system of claim 13, wherein the system further comprises a passive part.

16. The system of claim 13, wherein the system further comprises a vertical magnetic path consisting of a partially plated via filled with a magnetic material.

17. A method comprising:
providing a substrate with a first set of metal tracks;
depositing a magnetic material to the first set of metal tracks to make a magnetic core; and
connecting the first set of metal tracks vertically by vias or metal posts to a second set of metal tracks to form a winding.

18. The method of claim 18, wherein the magnetic core forms a closed structure on a layer of the substrate.

19. The method of claim 18, wherein the magnetic core has an air gap.

20. The method of claim 18, wherein the magnetic core is on an internal layer of the substrate.
